(19) United States
(12) Patent Application Publication
(10) Pub. No.: US 2023/0192549 A1
(43) Pub. Date: Jun. 22, 2023

(54) CEMENTITIOUS SKIM COAT COMPOSITIONS CONTAINING CROSSLINKED CELLULOSE ETHERS FOR MORTARS WITH ENHANCED GEL STRENGTH

(71) Applicant: Dow Global Technologies LLC, Midland, MI (US)

(72) Inventors: Amit Kumar Verma, Uttar Pradesh (IN); Jörn Breckwoldt, Hamburg (DE); Jörg Neubauer, Hamburg (DE)

(21) Appl. No.: 17/925,959

(22) PCT Filed: Aug. 30, 2021
(86) PCT No.: PCT/US2021/048155

§ 371 Date: Nov. 17, 2022

(30) Foreign Application Priority Data
Sep. 1, 2020 (IN) 202011037639

(51) Int. Cl. C04B 24/38; C04B 28/04; C04B 40/06

(52) U.S. Cl. CPC C04B 24/386; C04B 28/04; C04B 40/0608; C04B 2111/00517

(57) ABSTRACT

The present invention provides dry mixes for skim coat mortars having improved pot life and workability while reducing cellulose ether dosage comprising a white cement, one or more fillers having a sieve average particle size of from 15 to 60 microns, from 0.25 to 0.5 wt. % of one or more gel-like crosslinked cellulose ethers containing polyether groups, preferably, a mixed cellulose ether having polyoxypropylene dioxyethylene ether crosslinks, and from 1 to 2.5 wt. % of one or more polymer redispersible powders (RDP). At least one gel-like crosslinked cellulose ether has a crossover point as measured by oscillation rheometry, at which storage modulus (G′) and loss modulus (G″) intersect and are identical, of 1.0ω or less. The present invention also provides methods of using the dry mixes.

### FIELD OF THE INVENTION

The present invention relates to dry mix compositions comprising cement and gel-like crosslinked cellulose ethers containing polyether groups and having enhanced workability and pot life for use in making cementitious skim coats, as well as methods for using the compositions.

### BACKGROUND OF THE INVENTION

Cellulose ethers are employed in mortars in various construction applications impart water retention properties that limit loss of water from the mortar to absorbing substrates as well as to improve the rheology of the mortar. For example, cellulose ethers have found use in cement based tile adhesives, by applying a wet adhesive to the back of a tile and adhering it to a substrate. Additionally, cellulose ethers allow for a steady setting rate and high final mechanical strength. However, cellulose ethers pose drawbacks as highly viscous cellulose ethers, those with a viscosity level of above 70000 mPa·s (measured by Haake™ Viscotester™ VT550 rheometer by Thermo Fisher Scientific, USA), 2 wt. % aq. solution, 2.55 s⁻¹ at 20° C.), are difficult to access because of the difficulty in sourcing and processing raw material (pulp). When using more readily available cellulose ethers, the addition rate or dosage of cellulose ether remains high, for example, 0.3 to 0.6 wt. %, based on total solids, to create sufficient water retention to retain a useful pot life. There remains a need to reduce the dosage of cellulose ether in, for example, skim coat applications.

Cement containing skim coats comprise dry mix compositions for mortars that are formulated with cellulose ethers, cement and finely milled fillers. For skim coat applications, dry mortars are mixed with water and afterwards are thinly applied in successive layers over an application window of, for example, from three to four hours. In the application window, if the skim coat mortar fails to retain good hand-tool workability and initial wet mortar properties, like tack and consistency, it has to be discarded and a new mortar batch must be made. However, the desired reduction of cellulose ether dosage level through formulation of skim coats with higher viscosity cellulose ethers may impair the needed application properties of the mortar during the application window interval.

US patent publication US2015/0315076A1, to Li discloses skim coat compositions with cellulose ethers and gluconate salts, and enables a cellulose ether dosage reduction by replacement of cellulose ether with gluconate salt, limited to <18%, based on a 0.35% standard dosage. However, replacement of cellulose ether with gluconate slows down setting times, thereby preventing efficient skim coat application by delaying successive applications of skim coat and later application of an architectural coating on the skim coat.

The present invention seeks to solve the problems of providing cementitious skim coat dry mix compositions with cellulose ethers that form mortars having improved pot life and workability while reducing cellulose ether dosage.

### STATEMENT OF THE INVENTION

In accordance with the present invention, a dry mix composition for making a skim coat comprises a cement, such as a white cement, one or more fillers having a sieve average particle size of from 15 to 60 microns, from 0.15 to 0.75 wt. %, or, preferably, from 0.20 to 0.50 wt. %, or, more preferably, from 0.23 to 0.45 wt. %, of one or more gel-like crosslinked cellulose ethers containing polyether groups, preferably, a mixed cellulose ether that contains hydroxyalkyl groups and alkyl ether groups, and from 0.5 to 5 wt. %, or, from, 0.5 to 3.5 wt. %, or, preferably, from 1 to 2.5 wt. % of one or more polymer redispersible powders (RDP), such as RDPs containing ethylene-vinyl acetate copolymers, acrylate copolymers, or styrene acrylate copolymers, all amounts being wt. % of total solids in the dry mix composition. Preferably, at least one of the one or more gel-like crosslinked cellulose ethers is a mixed cellulose ether having polyoxypropylene dioxyethylene ether crosslinks. The dry mix compositions may comprise a dry cement, such as a white cement, in the amount of from 15 to 33 wt. %, or, preferably, from 18 to 30 wt. %, based on the total weight of dry mix with the remainder of the dry mix comprising one or more fillers, such as white fillers. All weight proportions add up to 100%.

In accordance with the present invention a method of using the dry mix comprises mixing the dry mix with water to form a mortar and applying the mortar to a substrate to form a skim coat. The substrate may comprise, for example, concrete, a fiber cement board, a cement render, a reinforcement mortar for exterior insulation finishing systems (EIFS), cured mortar, or another unfinished substrate.

Preferably, in either the composition or the method of the present invention, a 1.0 wt. % aqueous solution of at least one of the one or more gel-like crosslinked cellulose ethers has a crossover point (COV) as measured by oscillation rheometry, at which storage modulus (G′) and loss modulus (G″) intersect and are identical, of 1.5 (w or rad/s) or less, for example, from 0.2 to 1.0 rad/s, or, from 0.45 to 1.0 rad/s, the G′ and G″ being measured in Pascal at 20° C. using a oscillating rheometer (Anton Paar MCR 302, Anton Paar, Graz, AT) equipped with a plate having a 50 mm diameter and a cone having a 1° cone angle and a 0.05 mm flattening of the cone point, and varying the angular frequency (ω) in radians/s in a range of (ω) from 0.1 to 100 rad/s with a deformation of 0.5%. More preferably, a ratio of the COV of the gel-like crosslinked cellulose ether to the COV of the same cellulose ether absent crosslinking ranges from 1:15 to 0.5:1 or, preferably, from 0.1:1 to 0.4:1.

Preferably, at least one of the one or more gel-like crosslinked cellulose ethers has a degree of hydroxyalkyl substitution MS (HE) of 1.5 to 4.5 and a degree of substitution MS (HE) of 2.0 to 3.0.

Preferably, at least one of the one or more gel-like crosslinked cellulose ethers comprises a crosslinked cellulose ether at least partly from wood pulp in the amount of, for example, at least 20 wt. %, or from 20% to 100%, or, from 20% to 80%, based on the total solids weight of the cellulose ether.

More preferably, at least one of the one or more gel-like crosslinked cellulose ethers is a hydroxyethyl methyl cellulose containing polyoxypropylene dioxyethylene ether crosslinks, such as the reaction product of hydroxyethyl methyl cellulose with polypropylene glycol (PPG) glycidylether.

Preferably, the dry mix composition in accordance with the present invention provides a mortar wherein a 0.3 wt. % loading of at least one of the one or more gel-like crosslinked cellulose ether, based on the weight of total solids in the dry mix composition, provides a water retention after 3 hr, when tested on a cardboard substrate as per the method in DIN EN 1015, Part 8, at 25° C., of at least 94%, or, preferably, at least 95%, or, more preferably, at least 96%, or, more preferably, at least 97%.

1. In accordance with the present invention dry mix compositions for use in making cementitious skim coat mortars comprise from 15 to 33 wt. %, or, preferably, from 18 to 30 wt. % of a white cement, such as an aluminate cement or white portland cement, from 65 to 83 wt. %, or, preferably, from 68 to 80 wt. % of one or more fillers chosen from dolomite, kaolinite, calcium carbonate, talc, silica sand, white silica sand, or alkali metal silicates, such as calcium silicate or sodium silicate, the filler having a sieve average particle size of from 15 to 60 microns, or, preferably, from 25 to 50 microns, from 0.15 to 0.75 wt. %, or, preferably, from 0.20 to 0.5 wt. %, or, more preferably, from 0.35 to 0.45 wt. % of one or more gel-like crosslinked cellulose ethers containing polyether groups, and from 0.5 to 5 wt. %, or, preferably, from 1 to 2.5 wt. % or, more preferably, from 1.4 to 2 wt. %, of one or more polymer redispersible powders (RDP), such as ethylene-vinyl acetate RDP, all amounts being wt. % of total solids in the dry mix composition and all proportions adding up to 100%.

2. In accordance with the dry mix compositions of item 1, above, at least one of the one or more gel-like crosslinked cellulose ethers is the crosslinked reaction product of a crosslinked cellulose ether which, absent crosslinking, would have a viscosity of from 10,000 to 70,000 mPa·s measured as a 2 wt. % solution in water using a rotational rheometer (Haake™ Viscotester™ VT550 by Thermo Fisher Scientific, USA) at 20° C. and a shear rate 2.55 s⁻¹.

3. In accordance with the dry mix compositions any one of items 1 or 2, above, at least one of the one or more gel-like crosslinked cellulose ethers is chosen from a non mixed cellulose ether that contains alkyl ether groups, or a mixed cellulose ether that contains hydroxyalkyl groups and alkyl ether groups, such as those chosen from alkyl hydroxyethyl celluloses, e.g. hydroxyalkyl methylcelluloses, and is, preferably, chosen from hydroxyethyl methylcellulose (HEMC), hydroxypropyl methylcellulose (HPMC), methyl hydroxyethyl hydroxypropylcellulose (MHEHPC), methyl ethyl hydroxyethyl cellulose (MEHEC) and ethylhydroxyethyl cellulose (EHEC), or, more preferably, HEMC.

4. In accordance with the dry mix compositions of any one of items 1, 2, or 3, above, wherein the polyether group in at least one of the one or more gel-like crosslinked cellulose ethers is a polyoxyalkylene which has from 2 to 100 or, preferably, 2 to 20, or, more preferably, from 3 to 15 oxyalkylene groups.

5. In accordance with the dry mix compositions of any one of items 1, 2, 3, or 4, above, wherein the polyether group in at least one of the one or more gel-like crosslinked cellulose ethers is a polyoxyalkylene chosen a polyoxyethylene, a polyoxypropylenes and combinations thereof, preferably, a polyoxypropylene.

6. In accordance with the dry mix compositions of any one of items 1, 2, 3, 4, or 5, above, wherein the gel-like crosslinked cellulose ether is a polyoxypropylene group containing hydroxyethyl methylcellulose, or, preferably, a hydroxyethyl methyl cellulose containing polyoxypropylene dioxyethylene ether crosslinks.

7. Preferably, in accordance with the dry mix compositions of the present invention of any one of items 1, 2, 3, 4, 5, or 6, above, a 1.0 wt. % aqueous solution of at least one of the one or more gel-like crosslinked ethers has a crossover point as measured by oscillation rheometry, at which storage modulus (G′) and loss modulus (G″) intersect and are identical, of 1.5 w or less, the G′ and G″ being measured in Pascal at 20° C. using an Anton Paar MCR 302 (Anton Paar, Graz, AT). equipped with a plate having a 50 mm diameter and a cone having a 1° cone angle and a 0.05 mm flattening of the cone point, and varying the angular frequency (ω) in radians/s in a range of (ω) from 0.1 to 100 with a deformation of 0.5%.

8. In accordance with the dry mix compositions of the present invention of any one of items 1, 2, 3, 4, 5, 6, or 7, above, a 0.3 wt. % loading of at least one of the one or more gel-like crosslinked cellulose ethers in the dry mix, based on the weight of total solids in the dry mix composition, provides a dry mix that when mixed with water to a viscosity of from 380,000 to 450,000 cPs (mPa·s) at 25° C., as measured using a Brookfield rheometer RVDV II Pro (DV II) equipped with a Helipath spindle no T96 at 5 rpm, provides a workable mortar that exhibits a water retention, when tested after 3 hr on a cardboard substrate as per the method in DIN EN 1015, Part 8, at 25° C., of at least 94%, or, preferably, at least 95%, or, more preferably, at least 96%, or, even more preferably, at least 97%.

9. In another aspect of the present invention, the present invention provides methods of using the dry mix compositions of any one of items 1 to 8, above, comprising combining the dry mix composition with water or aqueous liquid to make a mortar, applying the mortar to an unfinished cement substrate, such as concrete or a cement render, to form a smooth surface.

10. In accordance with the methods of the present invention as set forth in item 9, above, the methods further comprise allowing the smooth surface to dry and applying an architectural coating, such as a paint, to the thus dried smooth surface.

11. In accordance with the methods of the present invention as set forth in any one of items 9 or 10, above, wherein at least one of the one or more gel-like crosslinked cellulose ethers of the dry mix is the crosslinked product of a cellulose ether which, absent crosslinking, would have a viscosity of from 10,000 to 70,000 mPa·s measured as a 2 wt. % solution in water using a Haake™ Viscotester™ VT550 at 20° C. and a shear rate 2.55 s⁻¹.

Preferably, in accordance with the methods of the present invention, the dry mix comprises at least one gel-like crosslinked cellulose ether having a polyether group which is a polyoxyalkylene which has from 2 to 100 or, preferably, 2 to 20, or, more preferably, from 3 to 15 oxyalkylene groups. More preferably, the polyether group in at least one gel-like crosslinked cellulose ether is a polyoxypropylene. More preferably, at least one gel-like crosslinked cellulose ether is a hydroxyethyl methyl cellulose containing polyoxypropylene dioxyethylene ether crosslinks.

Preferably, in accordance with the methods of the present invention, the dry mix comprises at least one gel-like crosslinked cellulose ether that exhibits a crossover point (COV) of storage modulus (G′) and loss modulus (G″), as measured by oscillation rheometry, of 1.5 w or less. More preferably, the ratio of the COV of the gel-like crosslinked cellulose ether to the COV of the same cellulose ether absent crosslinking ranges from 1:15 to 0.5:1 or, preferably, from 0.2:1 to 0.4:1.

Preferably, in accordance with the methods of the present invention, the dry mix wherein a 0.3 wt. % loading of at least one of the one or more gel-like crosslinked cellulose ethers in the dry mix, based on the weight of total solids in the dry mix composition, provides a dry mix that when mixed with water to a viscosity of from 380,000 to 450,000 cPs (mPa·s) at 25° C., as measured using a Brookfield rheometer RVDV II Pro (DV II) equipped with a Helipath spindle no T96 at 5 rpm, provides a workable mortar that exhibits a water retention, when tested after 3 hr on a cardboard substrate as per the method in DIN EN 1015, Part 8, at 25° C., of at least 94%, or, preferably, at least 95%, or, more preferably, at least 96%, or, even more preferably, at least 97%.

### DETAILED DESCRIPTION OF THE INVENTION

In accordance with the present invention gel-like crosslinked cellulose ethers enable the provision of dry mixes and mortars for use in making skim coats that have the same or improved workability and open time even with reduced cellulose ether dosage. The gel-like cellulose ethers are irreversibly crosslinked and exhibit a gel-like behavior marked by an increase in storage modulus at a low angular frequency in response to oscillation rheometry. The gel-like behavior translates into improved water retention, in use as, for example, a mortar.

It has been found that the use of crosslinked cellulose ethers containing polyether groups in the crosslinker, preferably cellulose ethers containing alkyl ether and hydroxyalkyl groups, significantly improve the behavior of cementitious skim coat compositions. For example, the skim coat mortars which have enhanced gel strength characteristics, such as, at a given concentration, a greater degree of thickening or viscosity and a more elastic state relative to the same cellulose ether which is not so crosslinked. In addition, the present invention enables the reduction of cellulose ether dosage up to more than 30% without compromising skim coat performance. For example, the gel-like crosslinked cellulose ether of the present invention enables the provision of skim coat compositions that exhibit improved workability at a lower dosage for gel-like CE at demanding high temperature (45° C.) application conditions. The gel-like crosslinked cellulose ethers of the present invention can be used at significantly lower addition rates than conventional crosslinked cellulose ethers to make an economical cementitious skim coat.

Unless otherwise indicated, all temperature and pressure units are room temperature (19 to 23° C.) and standard pressure (1 atm). And, unless otherwise indicated, all conditions include a relative humidity (RH) of 50%.

Unless the context clearly dictates otherwise, the singular forms “a,” “an,” and “the” include plural referents.

Unless defined otherwise, technical and scientific terms used herein have the same meaning as is commonly understood by one skilled in the art.

All phrases comprising parentheses denote either or both of the included parenthetical matter and its absence. For example, the phrase “(poly)oxyalkylene” includes, in the alternative, polyoxyalkylene and oxyalkylene.

All ranges recited are inclusive and combinable. For example, a disclosure of from 0.25 to 0.5 wt. %, or, preferably, from 0.35 to 0.45 wt. %, will include all of from 0.25 to 0.5 wt. %, or, preferably, from 0.35 to 0.45 wt. %, or, from 0.25 to 0.35 wt. %, or, from 0.25 to 0.45 wt. %, or, from 0.35 to 0.5 wt. %, or, from 0.45 to 0.5 wt. %.

As used herein, the term “anhydroglucose unit” or “AGU” refers to a monosaccharide in (co)polymerized form.

As used herein the term “aqueous” means that the continuous phase or medium is water and from 0 to 10 wt. %, based on the weight of the medium, of water-miscible compound(s). Preferably, “aqueous” means water.

As used herein, the phrase “based on total solids” refers to weight amounts of all of the non-volatile ingredients in a given composition, including synthetic polymers, cellulose ethers, acids, defoamers, hydraulic cement, fillers, other inorganic materials, and other non-volatile additives. Water, ammonia and volatile solvents are not considered solids.

As used herein, the term “crossover point” means the angular frequency (ω) as determined by oscillation rheometry, at which the storage modulus (G′) and loss modulus (G″) intersect and are identical, wherein G′ and G″ are measured in Pascal by oscillation rheometry as a function of angular frequency (ω) at 20° C. using an Anton Paar MCR 302 oscillating rheometer (Anton Paar, Graz, AT) equipped with a plate having a 50 mm diameter and a cone having a 1° cone angle and a 0.05 mm flattening of the cone point, varying angular frequency (ω) in radians/s in a range of (ω) from 0.1 to 100 with a deformation of 0.5%. In the rheometry, the analyte cellulose ether or crosslinked cellulose ether is dissolved in water by dispersing 1.0 wt. % of the cellulose ether under shear, on a dry basis, in 99.0 wt. % of water over 1 minute in the water at room temperature with stirring, followed by stirring at 1000 rpm for 10 min, then storing the solution over 24 h in a round glass vessel tightly sealed with a lid and rotated slowly about its longitudinal (horizontal) axis for the full 24 hours.

As used herein the term “DIN EN” refers to a European Norm version of a German materials specification, published by Beuth Verlag GmbH, Berlin, DE. And, as used herein, the term “DIN” refers to the German language version of the same materials specification.

As used herein the term “dry mix” means a storage stable powder containing cement, cellulose ether, any other polymeric additive, and any fillers and dry additives. No water is present in a dry mix; hence it is storage stable.

As used herein the term “DS” is the mean number of alkyl substituted OH-groups per anhydroglucose unit in a cellulose ether . . . the term “MS” is the mean number of hydroxyalkyl substituted OH-groups per anhydroglucose unit, as determined by the Zeisel method. The term “Zeisel method” refers to the Zeisel Cleavage procedure for determination of MS and DS, see G. Bartelmus and R. Ketterer, Fresenius Zeitschrift fuer Analytische Chemie, Vol. 286 (1977, Springer, Berlin, DE), pages 161 to 190.

As used herein the term “low or medium viscosity crosslinked cellulose ether” means a crosslinked cellulose ether which, absent crosslinking, would have a viscosity of from 10,000 to 40,000 mPa·s measured as a 2 wt. % solution in water using a Haake Rotovisko™ RV 100 rheometer (Thermo Fisher Scientific, Karlsruhe, DE) at 20° C. and a shear rate 2.55 s⁻¹.

As used herein the term “high viscosity crosslinked cellulose ether” means a crosslinked cellulose ether which, absent crosslinking, would have a viscosity of more than 40,000 mPa·s measured as a 2 wt. % solution in water using a Haake Rotovisko™ RV 100 rheometer (Thermo Fisher Scientific, Karlsruhe, DE) at 20° C. and a shear rate 2.55 s⁻¹.

As used herein the term “set” refers to the curing of a mortar which happens under ambient conditions in the presence of water and continues as the mortar dries.

As used herein the term “sieve average particle size” means the average particle size determined by Malvern Panalytical Mastersizer 2000 (Malvern, UK).

As used herein the term “wt. % of total solids” means the weight of all non-volatile ingredients of a given composition, as determined by volatility at temperatures of 40° C. or below and atmospheric pressure. Volatiles include water, solvents that evaporate under conditions of ambient temperature and pressure, like methyl chloride.

Suitable cellulose ethers for use in the methods to make the crosslinked polyether group containing cellulose ethers of the present invention may include, for example, a hydroxyalkyl cellulose or an alkyl cellulose, or a mixture of such cellulose ethers. Examples of cellulose ether compounds suitable for use in the present invention include, for example, methylcellulose (MC), ethyl cellulose, propyl cellulose, butyl cellulose, hydroxyethyl methylcellulose (HEMC), hydroxypropyl methylcellulose (HPMC), hydroxyethyl cellulose (“HEC”), ethylhydroxyethylcellulose (EHEC), methylethylhydroxyethylcellulose (MEHEC), hydrophobically modified ethylhydroxyethylcelluloses (hmEHEC), hydrophobically modified hydroxyethylcelluloses (hmHEC), sulfoethyl methylhydroxyethylcelluloses (SEMHEC), sulfoethyl methylhydroxypropylcelluloses (SEMHPC), and sulfoethyl hydroxyethylcelluloses (SEHEC). Preferably, the cellulose ethers are mixed cellulose ethers that contain hydroxyalkyl groups and alkyl ether groups, such as alkyl hydroxyethyl celluloses, such as hydroxyalkyl methylcelluloses, for example, hydroxyethyl methylcellulose (HEMC), hydroxypropyl methylcellulose (HPMC), methyl hydroxyethyl hydroxypropylcellulose (MHEHPC), methyl hydroxyethylcellulose (MEHEC), and ethylhydroxyethyl cellulose (EHEC).

In the gel-like crosslinked cellulose ethers of the present invention, alkyl substitution is described in cellulose ether chemistry by the term “DS”. The DS is the mean number of substituted OH groups per anhydroglucose unit. The methyl substitution may be reported, for example, as DS (methyl) or DS (M). The hydroxy alkyl substitution is described by the term “MS”. The MS is the mean number of moles of etherification reagent which are bound as ether per mol of anhydroglucose unit. Etherification with the etherification reagent ethylene oxide is reported, for example, as MS (hydroxyethyl) or MS (HE). Etherification with the etherification reagent propylene oxide is correspondingly reported as MS (hydroxypropyl) or MS (HP). The side groups are determined using the Zeisel method (reference: G. Bartelmus and R. Ketterer, Fresenius Zeitschrift fuer Analytische Chemie 286 (1977), 161-190).

A crosslinked hydroxyalkyl group containing cellulose ether preferably has a degree of hydroxyalkyl substitution MS (HE) of 1.5 to 4.5, or, more preferably, a degree of substitution MS (HE) of 2.0 to 3.0.

Preferably, mixed ethers of methyl cellulose are used for the crosslinking. In the case of HEMC, a preferred methyl substitution DS (M) values ranges from 1.2 to 2.1 or, more preferably, from 1.3 to 1.7, or, even more preferably, from 1.35 to 1.65, and hydroxyalkyl substitution MS (HE) values range from 0.05 to 0.75, or, more preferably, from 0.10 to 0.45, or, even more preferably, 0.15 to 0.40. In the case of HPMC, preferably, DS (M) values range from 1.2 to 2.1, or, more preferably, from 1.3 to 2.0 and MS (HP) values range from 0.1 to 1.5, or, more preferably, from 0.15 to 1.2.

Crosslinking agents suitable for use in the present invention may include compounds having a polyoxyalkylene or polyalkylene glycol group and two or more, preferably, two crosslinking groups, such as glycidyl or epoxy groups, or ethylenically unsaturated groups, e.g. vinyl groups, that form ether bonds with the cellulose ether in crosslinking the cellulose ether. Suitable bifunctional compounds may be chosen from, for example, diglycidyl polyalkoxy ethers, diglycidyl phosphonate, divinyl polyoxyalkylenes containing a sulphone group. Examples of these are diglycidyl polyoxypropylenes and glycidyl(poly)oxyalkyl methacrylates, preferably, diglycidyl polyalkoxy ethers, e.g. diglycidyl polyoxypropylene; glycidyl(poly)oxyalkyl methacrylate; diglycidyl phosphonates; or divinyl polyoxyalkylenes containing a sulphone group.

The amount of crosslinking agent used may range from 0.0001 to 0.05 eq, where the unit “eq” represents the molar ratio of moles of the respective crosslinking agent relative to the number of moles of anhydroglucose units (AGU) of the cellulose ether. The preferred amount of crosslinking agent used is 0.0005 to 0.01 eq, or, more preferably, the amount of crosslinking agent used is 0.001 to 0.005 eq. As used herein, the unit “eq” represents the molar ratio of moles of the respective crosslinking agent relative to the number of moles of anhydroglucose units (AGU) in the cellulose ether; and, granulating and drying the resulting crosslinked polyether group containing cellulose ether.

The dry mix compositions in accordance with the present invention further comprise a finely divided cement, such as a hydraulic cement powder, preferably a white cement. Suitable examples of white cements are aluminate cements and white Portland cements comprising white inorganic materials. Dry cements may be used in amounts of from 15 to 33 wt. %, or, preferably, from 18 to 30 wt. %, based on the total weight of dry mix.

The dry mix compositions in accordance with the present invention further comprise from 65 to 83 wt. %, or, preferably, from 68 to 80 wt. % of a filler, preferably a white filler. Suitable fillers may be chosen from alkali carbonates and silicates, as well as calcined, sintered or ceramic forms thereof, such as dolomite, kaolinite, calcium carbonate, magnesium carbonate, talc, silica sand, white silica sand, or alkali metal silicates, such as calcium silicate, sodium silicate or their mixtures.

The dry mix compositions in accordance with the present invention may further include a water redispersible polymer powder (RDP). RDPs may be formed in a conventional manner by spray drying an emulsion polymer binder formed by conventional aqueous emulsion polymerization. Aqueous emulsion polymers may be selected from various compositional classes such as, for example, vinyl acetate polymers, vinyl acetate-acrylic copolymers, vinyl acetate-ethylene copolymers, acrylic polymers, styrene-acrylic polymers, styrene-butadiene copolymers, and blends thereof. RDP compositions further include anticaking agents such as clays and colloidal stabilizers, such as poly(vinylalcohol), which enable spray drying to form affinely divided powder. RDPs may improve adhesion and durability of the skim coat mortar.

Other ingredients in dry form such as accelerators, such as calcium formate, additional organic or inorganic thickening agents and/or secondary water retention agents, such as non-crosslinked cellulose ethers, anti-sag agents, wetting agents, defoamers, dispersants, water repellents, biopolymers, fibres or may be included in the dry mix compositions of the present invention. All of the other ingredients are known in the art and are available from commercial sources.

Methods for crosslinking cellulose ethers to make the polyether group containing cellulose ethers of the present invention may comprise crosslinking the cellulose ethers in a reactor in which the cellulose ether itself is made and in the presence of caustic or alkali. Thus, the crosslinking reaction is thus generally conducted in the process of making a cellulose ether. Because the process of making a cellulose ether comprises stepwise addition of reactants to form alkyl or hydroxyalkyl groups on cellulose, preferably, the crosslinking of the cellulose ethers is preceded by (i) one or more addition of alkyl halide, e.g. methyl chloride, in the presence of alkali to form alkyl ethers of the cellulose or (ii) alkylene oxide in the presence of alkali to form hydroxyalkyl groups on the cellulose; or (iii) both (i) and (ii).

Any step in the stepwise addition to form alkyl, hydroxyalkyl or ether groups on cellulose, whether it occurs before, during or after the crosslinking of the cellulose ethers may take place at a temperature of from 40 to 90° C., preferably, 70° C. or less, or, more preferably, 65° C. or less.

So that the cellulose ethers are not degraded or broken down in processing, the crosslinking reaction is carried out in an inert atmosphere and at temperatures of from room temperature to 90° C. or less, or, preferably, at as low a temperature as is practicable; for example, the process preferably is carried out at from 60° C. to 90° C. or, preferably, 70° C. or more.

After the polyether group containing cellulose ethers of the present invention are made, they are granulated and dried. Granulation may follow dewatering or filtering to remove excess water, if needed.

The skim coat dry mix compositions are formed by mixing all of the materials of the present invention in dry form. Cementitious skim coat compositions are generally used as a dry mix powder.

In accordance with the present invention, the methods of using the dry mix comprise combining the dry mix with water of to form a skim coat mortar applying the mortar to a substrate. Skim coat mortar may be applied on coarser substrates such as concrete or cement render in order to form a very smooth final coat. The final coat may be a smooth and homogeneous substrate for subsequent application of an architectural coating.

The mortar may be thinly applied in multiple, for example, three layers within an application window timeframe of three to four hours. During this time skim coat mortar retains good hand-tool workability and wet mortar properties, especially freshness/tack and consistency.

The compositions of the present invention find use as cementitious skim coats for concrete, such as walls, fiber cement boards, and cement renders.

### Examples

The following examples illustrate the present invention. Unless otherwise indicated, all parts and percentages are by weight and all temperatures are in ° C. In the examples and Tables 1, 2 and 3 that follow, the following abbreviations were used: RDP: Redispersible Polymer Powder; DGE: Diglycidyl ether; COV: Crossover value. The following materials were used:

Cement: White Portland cement (Birla White™ cement Ultra Tech Cement Ltd., Jodhpur, Rajasthan, IN) which has oxides of CaO₂, SiO₂ and Al₂O₃ and which meets an Indian standard IS: 8042-1989.

Crosslinked cellulose ether 1: DGE-crosslinked cellulose ether made from hydroxyethyl methylcellulose, DS (Methyl)=1.57; MS (hydroxyethyl)=0.28; viscosity of product 12690 mPa·s, 1% wt. % aq. solution, shear rate 2.55 s-1, 20° C. (Haake™ Viscotester™ VT550); COV=0.65 rad/s (Anton Paar MCR 302, Anton Paar). Crosslinked cellulose ether 1 was made from a non-crosslinked cellulose ether having a viscosity as a 1 wt. % aqueous solution using a Haake™ Viscotester™ VT550 viscometer at 20° C. and a shear rate 2.55 s⁻¹ of 9960 mPa·s and a COV of 3.3 rad/s. The COV ratio of the crosslinked cellulose ether to the same cellulose ether absent crosslinking is about 1:5.

Cellulose ether 2: Very high viscosity methylhydroxyethylcellulose powder (TYLOSE MHS 300000 P6, non-crosslinked, viscosity 8000 to 11000 mPa·s Brookfield RV, 20 UpM, 1.0 wt. % aq., 20° C., 20° dH, SE Tylose GmbH & Co. KG, Wiesbaden, DE).

Cellulose Ether 3: (WALOCEL™ MW 60000 PFV hydroxyethyl methyl cellulose (HEMC, DS (Methyl)=1.38; MS (hydroxyethyl)=0.21; viscosity 7830 mPa·s, 1 wt. % aq. Solution, Haake™ Viscotester™ VT550, shear rate 2.55 s-1, 20° C. (Dow)).

Crosslinker 1: Epilox™ M985 poly(propyleneglycol) diglycidylether crosslinker (Leuna-Harze GmbH, Leuna, DE) is a linear poly(propyleneglycol) diglycidylether made from polypropylene glycol (PPG), and having a molecular weight of 850-1000 g/mol and having the formula below;

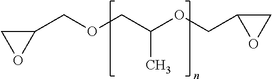

wherein n is 7 to 12.

RDP 1: DLP 2025 Redispersible Latex Powder (Dow, Midland Mich.) is a free-flowing, white powder obtained by spray drying an aqueous vinyl acetate ethylene copolymer dispersion in the presence of an anticaking agent and a colloidal stabilizer.

Filler: Dolomite, 37 micron (400 mesh) sieve average particle size.

Crosslinked cellulose ether Synthesis Example: A crosslinked HEMC cellulose ether was made by forming a cellulose ether from a blend of roughly 75 wt. % of wood pulp and 25 wt. % of cotton linters that, absent crosslinking, would have a viscosity as a 1 wt. % aqueous solution using a Haake™ Viscotester™ VT550 rheometer at 20° C. and a shear rate 2.55 s⁻¹ of 9960 mPa·s in the same manner as in Synthesis Example 1A of U.S. Pat. No. 10,150,704B2 to Hild et al. (Hild reference) and was further processed at 40° C. with Crosslinker 1 0.003 mol crosslinker/mol AGU (anhydroglucose units) in manner disclosed in Synthesis Example 3 of the Hild reference. The gel-like crosslinked cellulose ether than results has a viscosity of 12690 mPa·s (1 wt. %, Haake™ Viscotester™ VT550, D=2.55 s⁻¹, 20° C.).

Cellulose ethers were tested and characterized as discussed below in the form of aqueous solutions and, as well, in skim coat mortars having the indicated compositions as set forth in Table 1 and Table 2, below.

TABLE 1
Skim Coat Formulation

| Raw Materials | Composition (wt. %) |
|---|---|
| Cement | 25 |
| Dolomite (400 mesh) | 73.0* |
| Cellulose ether | up to 0.4 (see Table 3) |
| RDP 1 | 1.6 |
| Total | 100 |

*Where the formulation contains less than 0.4 wt. % of the cellulose ethers, the amount of dolomite is adjusted so that all proportions add up to 100%.

TABLE 2
Cellulose Ethers in Formulations

| Example | Cellulose Ether (CE) |
|---|---|
| 1 | Crosslinked cellulose ether 1 |
| 2 | Crosslinked cellulose ether 1 |
| 3* | Cellulose ether 2 |
| 4* | Cellulose ether 2 |
| 5* | Cellulose ether 3 |

*Denotes Comparative Example

Dry mixes were formed by weighing the indicated ingredients in Tables 1, 2 and 3, above, as individual raw materials carefully on an electronic balance, dry blending them as powders and letting them rest for 24 hours. The dry mix materials were then testing as indicated, below.

Water demand to determine the water powder ratio: Water demand shows consistency measured via viscosity of a mortar paste. A 500 gm of the indicated dry mix was mixed with premeasured quantity (in range of 35 to 40% of drymix) of water, which is roughly <40% less than is needed to make a mortar, in a Hobart mixer at constant speed at 25° C. to ensure the desired consistency of from 380,000 to 450,000 cPs or mPa·s. Mixing was continued for 1 min; the material was then let to rest for 3 min; then, the material was mixed again for 1 min to form a paste. The paste was filled in a 500 ml container to measure the viscosity using a Brookfield rheometer (DVII) equipped with a Helipath spindle no T96 at 5 rpm to achieve a target viscosity. If the paste achieved a desired viscosity of from 380,000 to 450,000 cPs (mPa·s) at 25° C., then the water level was reported as the water demand of the formulation. Otherwise, more water, if needed, was added to meet the target viscosity.

Workability: A visual test method to determine ease of application, hand feel and levelling, workability was determined from the indicated paste after the determination of water demand. Workability was measured by applying the skim coat paste on a fiber cement board (30.72 cm×30.72 cm) using a flat edge steel trowel (20.48 cm length) at 25° C. The rating, from 9 to 1, was determined by an experienced lab technician; a higher rating means better workability. Rating was, as follows:

9: Excellent, creamy consistency, no stickiness, ease of leveling
7: Good, creamy consistency, ease of leveling
5: Fair, buttery consistency little difficult for ease of level & bit sticky
3: Hard, buttery consistency, no ease of leveling, very fast drying and peeling effect
1: Bad consistency, not workable

Pot Life: To determine pot life, a 1 kg sample of the indicated skim coat paste was kept in a pot at 25° C. and its workability was checked, as above, after 1, 2 and 3 hr. Based on the workability rating, the pot life of the sample was recorded after the indicated time period.

Water Retention (%): Water retention of the indicated mortar was tested on a cardboard substrate as per the method in DIN EN 1015, Part 8, at 25° C. to show the amount of water retained (expressed in percent) in the indicated paste after capillary water removal via the absorbing substrate. Water retention thus indicates the effectiveness of cellulose ethers as water retention agents in inorganic mortar systems. After the indicated period (for example, 60 min, or 180 min) the absorbed water amount was measured. To be acceptable, water retention must be >95% after 3 hr.

Crossover Point or Crossover Value (COV): This gel strength test was run via oscillation rheology, as defined above, with the indicated cellulose ethers as a 1 wt. % aqueous solution. The indicated cellulose ether or crosslinked cellulose ether was dissolved in water in the amount of 1.0 parts by weight of the cellulose ether, on a dry basis, and 99.0 parts per weight of water. To make the aqueous solution, the cellulose ether was dispersed over 1 minute in the water at room temperature with stirring to avoid the formation of lumps. Afterwards the mixture was stirred at 1000 rpm for 10 min. Then over 24 h, the solution was stored in a round glass vessel tightly sealed with a lid and rotated slowly about its longitudinal (horizontal) axis for the full 24 hours.

The characteristics of the various cellulose ether materials and skim coat mortars tested in the Examples are shown in Table 3, below.

TABLE 3
Results of Test Methods

| Example | 1 | 2 | 3* | 4* | 5* |
|---|---|---|---|---|---|
| MC % Reduction¹ | 30% | 35% | 30% | 35% | Ref |
| Wt % in Dry Mix | | | | | |
| Cellulose Ether amount | 0.28 | 0.26 | 0.28 | 0.26 | 0.4 |
| RDP 1 | 1.6 | 1.6 | 1.6 | 1.6 | 1.6 |
| CEMENT | 25 | 25 | 25 | 25 | 25 |
| Filler | 73.12 | 73.14 | 73.12 | 73.14 | 73 |
| Total | 100 | 100 | 100 | 100 | 100 |
| WATER DEMAND (%) | 36 | 35.5 | 35.5 | 35 | 35.5 |
| Workability/Potlife | | | | | |
| 1st Coat immediate/10 min | 8.5 | 8.5 | 8.5 | 8.5 | 8.5 |
| 2nd coat after 3 hr/pot life | 7.5 | 7.5 | 7 | 4.5 | 8 |
| Potlife/Workability at High | 8 | 7.5 | 7 | 1 | 8 |
| Temp (45° C. for 20 min) | | | | | |
| Water Retention (%) | | | | | |
| After 3 Hr | 98 | 96.4 | 93.9 | 92.0 | 95.9 |

*Denotes Comparative Example; 1. Reduction values represent the reduction in % amount of cellulose ether used as compared to Example 5 (0.4 wt. %).

As shown in Table 3, above, the inventive dry mix compositions of inventive Examples 1 and 2 enable the use of a lower proportion of the crosslinked cellulose ether to maintain excellent water demand and workability/potlife. The inventive compositions exhibit dramatically improved water retention compared to all Comparative Examples (compare Ex 1 to C.Ex 3 and 5; and compare Ex 2 to C.Ex 4). The inventive compositions surprisingly enable such properties, including improved workability at a lower dosage for gel-like CE at demanding high temperature application conditions.

1. A dry mix composition for use in making cementitious skim coat mortars comprising from 15 to 33 wt. % of a white cement, from 65 to 83 wt. % of one or more fillers having a sieve average particle size of from 15 to 60 microns and chosen from dolomite, kaolinite, calcium carbonate, talc, silica sand, white silica sand, or alkali metal silicates, from 0.15 to 0.75 wt. % of one or more gel-like crosslinked cellulose ethers containing polyether groups, and from 0.5 to 5 wt. % of one or more polymer redispersible powders (RDP), all amounts being wt. % of total solids in the dry mix composition and all proportions adding up to 100%.

2. The dry mix composition as claimed in claim 1, wherein at least one of the one or more gel-like crosslinked cellulose ethers is a crosslinked cellulose ether which, absent crosslinking, would have a viscosity of from 10,000 to 70,000 mPa·s measured as a 2 wt. % solution in water using a Haake™ Viscotester™ VT550 rheometer at 20° C. and a shear rate 2.55 s⁻¹.

3. The dry mix composition as claimed in claim 2, wherein a 1.0 wt. % aqueous solution of at least one of the one or more the gel-like crosslinked cellulose ethers has a crossover point (COV) as measured by oscillation rheometry, at which storage modulus (G′) and loss modulus (G″) intersect and are identical, of 1.0 w or less, the G′ and G″ being measured in Pascal at 20° C. using a Universal Dynamic Spectrometer™ UDS 200 oscillating rheometer equipped with a plate having a 50 mm diameter and a cone having a 1° cone angle and a 0.05 mm flattening of the cone point, and varying the angular frequency (ω) in radians/s in a range of (ω) from 0.1 to 100 with a deformation of 0.5%.

4. The dry mix composition as claimed in claim 1, wherein the polyether group in at least one of the one or more gel-like crosslinked cellulose ethers is a polyoxyalkylene chosen from a polyoxyethylene, a polyoxypropylene and combinations thereof.

5. The dry mix composition as claimed in claim 1, wherein at least one of the one or more gel-like crosslinked cellulose ethers is a mixed cellulose ether that contains hydroxyalkyl groups and alkyl ether groups.

6. The dry mix composition as claimed in claim 5, wherein at least one of the one or more gel-like crosslinked cellulose ethers is a non-mixed cellulose ether that contains alkyl ether groups.

7. The dry mix composition as claimed in claim 1, wherein at least one of the one or more the gel-like crosslinked cellulose ethers is a polyoxypropylene group containing hydroxyethyl methylcellulose.

8. The dry mix composition as claimed in claim 1, wherein at least one of the one or more the gel-like crosslinked cellulose ethers is a mixed cellulose ether having polyoxypropylene dioxyethylene ether crosslinks.

9. The dry mix composition as claimed in claim 1, wherein at least one of the one or more the gel-like crosslinked cellulose ethers is the reaction product of hydroxyethyl methyl cellulose with polypropylene glycol (PPG) glycidylether.

10. A method of using the dry mix compositions as claimed in claim 1, comprising combining the dry mix composition with water or aqueous liquid to make a mortar, and applying the mortar to a substrate to form a skim coat.
